(19) United States
(12) Patent Application Publication
(10) Pub. No.: US 2021/0302721 A1
(43) Pub. Date: Sep. 30, 2021

(54) OPTICAL SCANNING APPARATUS

(71) Applicant: CANON KABUSHIKI KAISHA, Tokyo (JP)

(72) Inventor: Taku Murotani, Shizuoka (JP)

(21) Appl. No.: 17/211,629

(22) Filed: Mar. 24, 2021

(30) Foreign Application Priority Data
Mar. 31, 2020 (JP) 2020-063776

(51) Int. Cl. G02B 26/10; G02B 26/08; G03G 15/043

(52) U.S. Cl. CPC G02B 26/105; G03G 15/043; G02B 26/0816

(57) ABSTRACT

In an optical scanning apparatus, a first positioning portion has two seating surfaces that hold a mirror and a second positioning portion has only one seating surface that holds the mirror. A force of pressure of a first urging member is greater than a force of pressure of a second urging member, thereby preventing a vibration of the mirror.

### BACKGROUND

### Field of the Disclosure

The present disclosure relates to an optical scanning apparatus used for an image forming apparatus using an electrophotographic method, such as a laser printer and a digital copying machine.

### Description of the Related Art

In many cases, an optical scanning apparatus that scans a photosensitive member mounted in an electrophotographic image forming apparatus with a laser beam in accordance with image information is equipped with a mirror to deflect an optical path of the laser beam.

If an orientation of the mirror is displaced from a desired orientation, an irradiation position of the laser beam to the photosensitive member is shifted. Thus, in an optical scanning apparatus discussed in Japanese Patent Application Laid-Open No. 2002-182144, a structure of holding a mirror is proposed to make the orientation of the mirror in the desired orientation.

The mirror is typically positioned on a seating surface of an optical box by being urged by a spring. Accordingly, the seating surface on which the mirror is mounted requires accuracy. However, in a case where the optical box is a resin molded product, it is conceivable that the accuracy of the seating surface deteriorates due to a variation at the time of molding. The deterioration in accuracy of the seating surface may make the orientation of the mirror unstable.

FIGS. 9A and 9B are diagrams illustrating an issue to be solved in the present exemplary embodiment, and each schematically illustrate a state in which the mirror is held by the seating surface. FIG. 9B is a sectional view taken along a line b-b illustrated in FIG. 9A. A mirror 101 is positioned on seating surfaces 103 and 203 at respective ends in a longitudinal direction of the mirror 101. The seating surfaces 103 and 203 at two different positions having an identical shape. The one seating surface 103 that holds the mirror 101 includes seating surfaces 103a and 103b that are in contact with the mirror 101, and a seating surface 117 in contact with a surface 116 of the mirror 101. The other seating surface 203 that holds the mirror 101 includes seating surfaces 203a and 203b that are in contact with the mirror 101, and a seating surface 118 in contact with the surface 116 of the mirror 101. The mirror 101 includes a reflection surface 114.

FIGS. 10A and 10B each illustrate an example in which accuracy of part of the seating surfaces deteriorates due to a variation at the time of molding an optical box 102. The example illustrated in FIGS. 10A and 10B is an example in which the seating surface 103b is lower than the seating surface 103a. In this case, a straight line B connecting the seating surfaces 103a and 103b of the one seating surface 103, and a straight line C connecting the seating surfaces 203a and 203b of the other seating surface 203 are in a non-parallel state. If the one seating surface 103 and the other seating surface 203 fail to have a parallel relationship, a gap 119 is generated between the mirror 101 and the seating surface 103b.

FIG. 11A is a diagram illustrating a case where the gap 119 is generated between the mirror 101 and the seating surface 103. FIG. 11B is a diagram illustrating a case where a gap 219 is generated between the mirror 101 and the seating surface 203. As illustrated in FIG. 11A, the mirror 101 is urged by a force F11 of a spring, which is not illustrated, at its center in a traverse direction of the mirror 101 on the one seating surface 103 side in the longitudinal direction of the mirror 101 toward the seating surface 103. With the presence of the gap 119, the force F11 generates a moment M11. In a case where the force F11 is insufficient, the size of the gap 119 changes depending on the magnitude of the force F11.

Also on the other seating surface 203 side, the mirror 101 is urged by a force F31 of a spring, which is not illustrated, toward the seating surface 203. However, as illustrated in FIG. 11B, the mirror 101 floats from the seating surface 203a by a moment M21 corresponding to the moment M11 generated on the one seating surface 103 side. Consequently, the gap 219 is generated between the mirror 101 and the seating surface 203a.

The gaps 119 and 219 respectively generated by the moments of forces M11 and M21 are located on a diagonal line T connecting opposing corners 113 and 213 of the mirror 101, as illustrated in FIG. 12A. Consequently, rotational motion of the mirror 101 is generated about the diagonal line T serving as an axis.

FIG. 12B is a diagram illustrating a relationship between the mirror 101 and a laser beam LB with which a photosensitive member D is irradiated. Driving a motor of a deflector that deflects a laser beam transmits its vibration to the mirror 101 via the optical box 102. In a case where the gap 119 is present between the mirror 101 and the seating surface 103a and the gap 219 is present between the mirror 101 and the seating surface 203a, the vibration generates rotational motion of the mirror 101 at an angle θ. Then, an irradiation position of the laser beam LB varies by a width A and the variation in irradiation position occurs at a vibration period of the deflector, which causes banding, and eventually leads to deterioration in image quality.

### SUMMARY

Aspects of the present disclosure include an optical scanning apparatus capable of reducing shift amount of an irradiation position of a laser beam due to a vibration of a mirror by surely bringing the mirror into contact with a positioning portion.

According to an aspect of the present disclosure, an optical scanning apparatus includes a light source configured to emit a laser beam, a deflector configured to deflect the laser beam emitted from the light source and perform scanning with the laser beam, a mirror having a length greater than its width and configured to reflect the laser beam, an optical box, configured to house the deflector and the mirror, including a first positioning portion configured to hold one end of the mirror and a second positioning portion configured to hold the other end, in the longitudinal direction, of the mirror, a first urging member configured to urge the mirror toward the first positioning portion, and a second urging member configured to urge the mirror toward the second positioning portion, wherein the first positioning portion has two seating surfaces configured to hold the mirror, and the second positioning portion has one seating surface configured to hold the mirror, and wherein a force of pressure of the first urging member is greater than a force of pressure of the second urging member.

Further features of the present disclosure will become apparent from the following description of exemplary embodiments with reference to the attached drawings.

### BRIEF DESCRIPTION OF THE DRAWINGS

FIG. 1 is a diagram illustrating an optical scanning apparatus according to an exemplary embodiment.

FIGS. 2A to 2C are diagrams each illustrating one mirror mounting portion according to the exemplary embodiment.

FIG. 3 is a sectional view illustrating the other mirror mounting portion according to the exemplary embodiment.

FIG. 4 is a sectional view illustrating one seating surface in a case where accuracy of the seating surface deteriorates in the exemplary embodiment.

FIGS. 5A and 5B are sectional views each illustrating the other seating surface in a case where accuracy of the seating surface deteriorates in the exemplary embodiment.

FIGS. 6A and 6B are schematic views each illustrating the seating surface according to the exemplary embodiment.

FIG. 7 is a plan view illustrating a modification example of the exemplary embodiment.

FIGS. 8A and 8B are sectional views each illustrating a modification example of the exemplary embodiment.

FIG. 9A is a plan view illustrating a relationship between a mirror and a seating surface, and FIG. 9B is a sectional view taken along a line b-b in FIG. 9A.

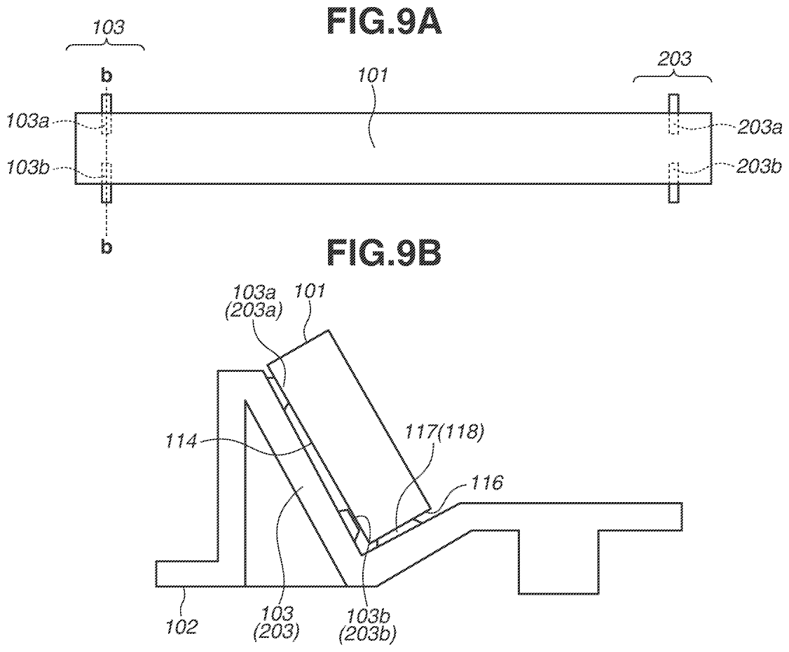

FIGS. 10A and 10B are sectional views each illustrating a state in which a gap is generated between the mirror and the seating surface.

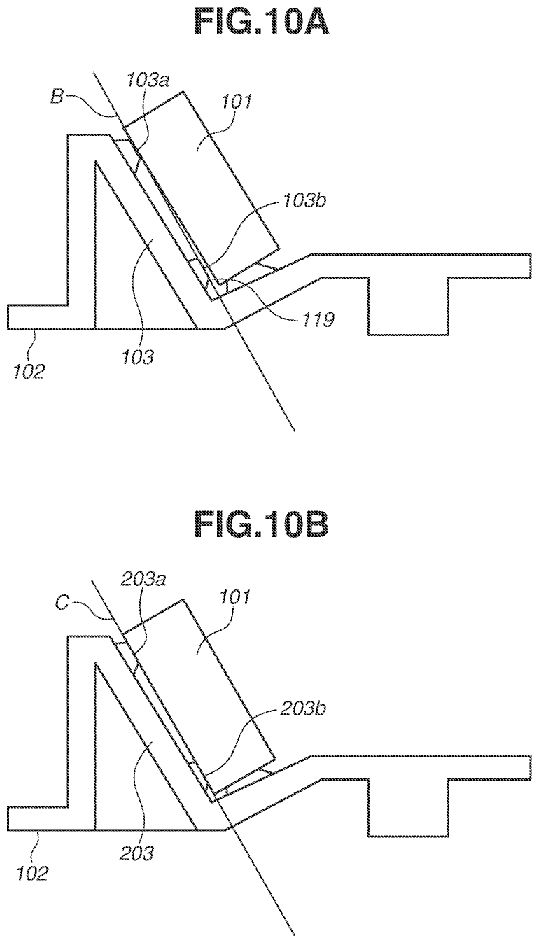

FIGS. 11A and 11B are sectional views each illustrating a moment of force acting on the mirror.

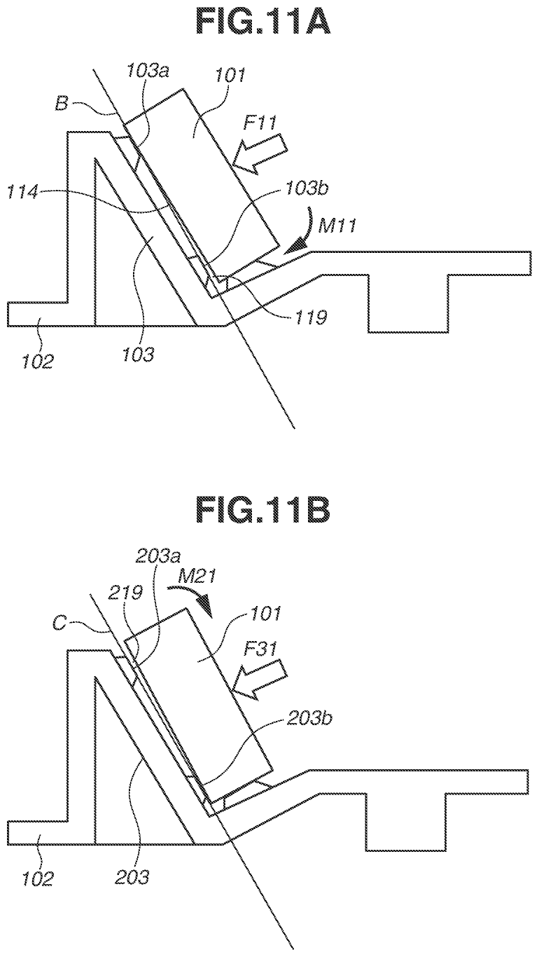

FIGS. 12A and 12B are schematic views each illustrating shift of an irradiation position of a laser beam.

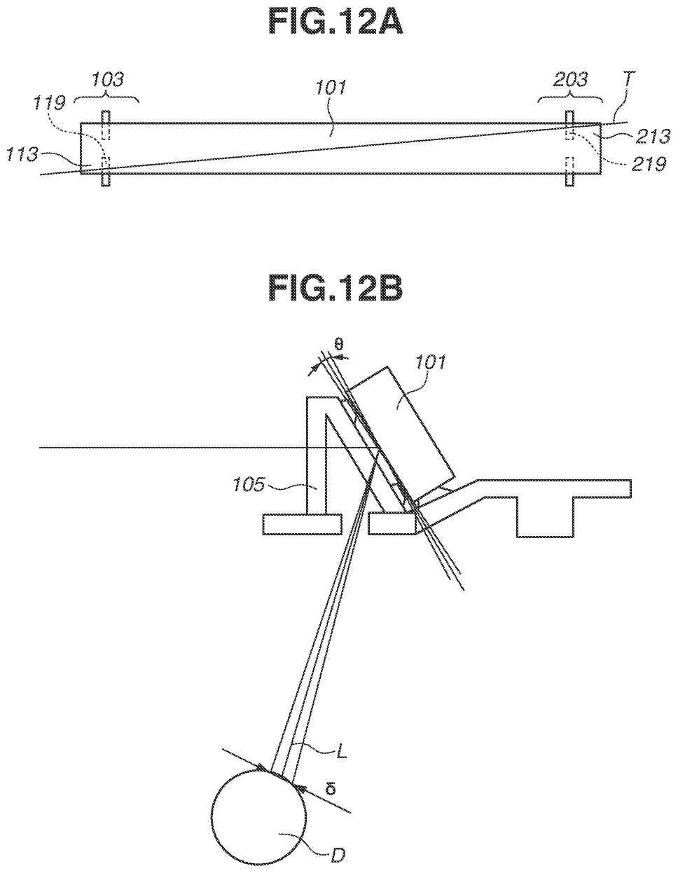

### DESCRIPTION OF THE EMBODIMENTS

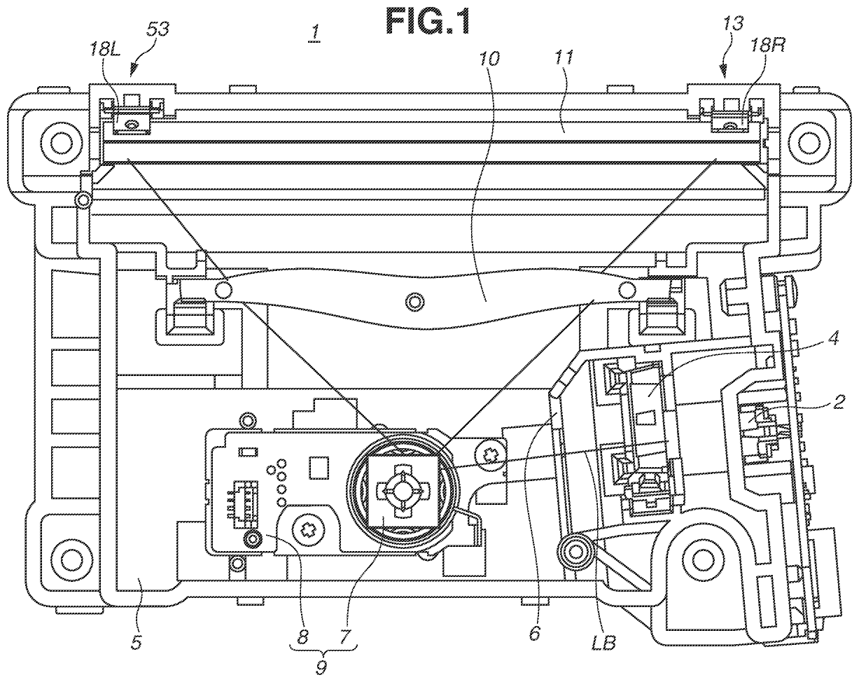

FIG. 1 is a plan view illustrating an optical scanning apparatus 1 according to an exemplary embodiment. A laser beam LB emitted from a light source unit (light source) 2 is collected by an anamorphic lens 4, and a beam diameter of the laser beam LB is restricted to a predetermined beam diameter by an optical diaphragm 6 formed in an optical box 5. Then, the laser beam LB is incident on a rotational polygon mirror 7. The rotational polygon mirror 7 is driven by a motor mounted on a driving circuit substrate 8 to deflect the laser beam LB incident thereon. The rotational polygon mirror 7 and the driving circuit substrate 8 constitute a deflector 9. The deflected laser beam LB, after passing through a fθ lens 10, is reflected on a long-length mirror 11, and scans a photosensitive member (not illustrated) mounted in an electrophotographic printer. As a result, an electrostatic latent image is formed on the photosensitive member. The mirror 11 is fixed to the optical box 5, which is a resin molded product, by a plate spring 18R (first urging member) and a plate spring 18L (second urging member) urging respective ends in a longitudinal direction of the mirror 11. In this manner, the optical scanning apparatus 1 includes the light source 2 that emits the laser beam LB and the deflector 9 that deflects the laser beam LB emitted from the light source 2 and that performs scanning with the laser beam LB. The optical scanning apparatus 1 further includes the long-length mirror 11 that reflects the laser beam LB and the optical box 5 that houses the deflector 9 and the mirror 11. The optical box 5 includes a first positioning portion 13 that holds one end in the longitudinal direction of the mirror 11 and a second positioning portion 53 that holds the other end in the longitudinal direction of the mirror 11. The first positioning portion 13 and the second positioning portion 53 will be described below. Furthermore, the optical scanning apparatus 1 includes the first urging member 18R that urges the mirror 11 toward the first positioning portion 13 and the second urging member 18L that urges the mirror 11 toward the second positioning portion 53.

### <Seating Surface>

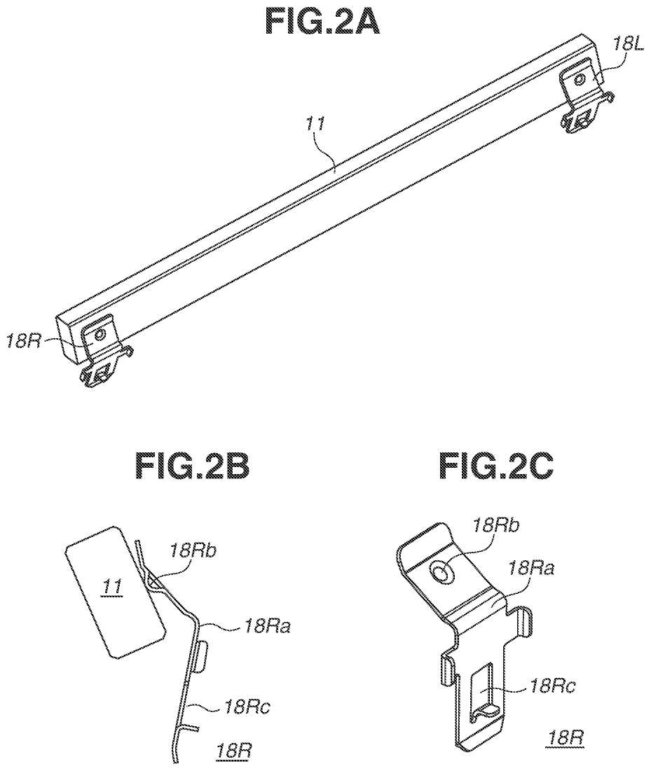

FIG. 2A is a perspective view illustrating a case where the mirror is pressed by the plate springs 18R and 18L. FIG. 2B is a sectional view of the plate spring 18R. FIG. 2C is a perspective view of the plate spring 18R. The plate springs 18L and 18R have an identical configuration.

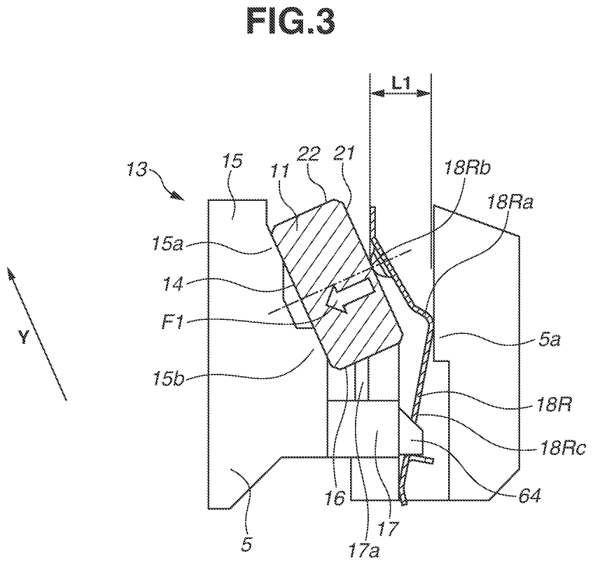

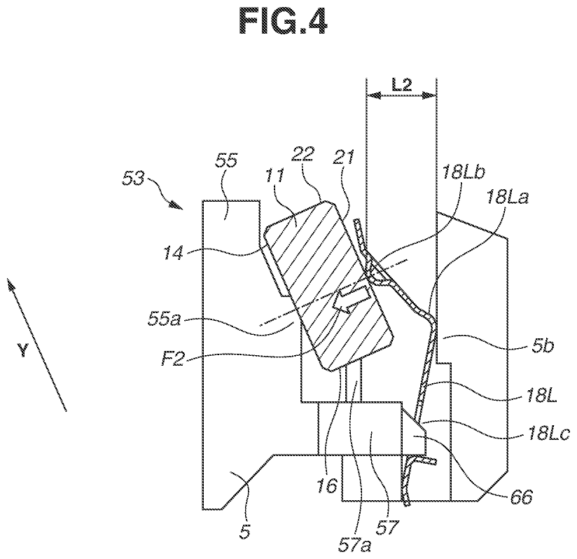

FIGS. 3 and 4 are diagrams each illustrating a state in which the mirror 11 is mounted on the optical box 5. FIG. 3 is a sectional view illustrating the one end in the longitudinal direction of the mirror 11 (main scanning direction of the laser beam LB). FIG. 4 is a sectional view illustrating the other end of the mirror 11. As illustrated in FIGS. 1 and 3, the optical box 5 is provided with the positioning portion 13 (first positioning portion) that holds the one end of the mirror 11. The positioning portion 13 includes a base 15 that supports a reflection surface 14 of the mirror 11, and a base 17 that supports a surface 16 of the mirror 11 orthogonal to the reflection surface 14. The base 15 includes seating surfaces 15a and 15b that support the reflection surface 14 at different two positions in a sub-scanning direction of the laser beam LB (Y-direction indicated by arrow). The base 17 includes a projection portion 17a that contacts the surface 16 of the mirror 11.

In addition, as illustrated in FIGS. 1 and 4, the optical box 5 is provided with the positioning portion 53 (second positioning portion) that holds the other end of the mirror 11. The positioning portion 53 includes a base 55 that supports the reflection surface 14 of the mirror 11, and a base 57 that supports the surface 16 of the mirror 11 orthogonal to the reflection surface 14. The base 55 includes a seating surface 55a that supports the reflection surface 14 at one position in the sub-scanning direction of the laser beam LB (Y-direction indicated by arrow). The base 57 includes a projection portion 57a that contacts the surface 16 of the mirror 11.

<Mounting Mirror with Plate Spring>

The mirror 11 is, after being placed on the optical box 5, urged by the plate springs 18R and 18L to be fixed to the optical box 5. The plate spring 18R includes a pressure application portion (first pressure application portion) 18Rb that applies pressure to the mirror 11, and a hole (first hole) 18Rc to fix the plate spring 18R to the optical box 5. The plate spring 18R includes a rear surface 18Ra. Similarly, the plate spring 18L includes a pressure application portion (second pressure application portion) 18Lb that applies pressure to the mirror 11 and a hole 18Lc (second hole) to fix the plate spring 18L to the optical box 5. The plate spring 18L includes a rear surface 18La. The plate springs 18R and 18L are sandwiched between the optical box 5 and the mirror 11. A claw (first claw) 64 and a claw (second claw) 66, which are part of the optical box 5, are respectively inserted into the holes 18Rc and 18Lc for fixing, and the plate springs 18R and 18L are respectively fixed to the optical box 5 by the claws 64 and 66.

As illustrated in FIG. 3, the plate spring 18R at one end in the longitudinal direction of the mirror 11 is arranged on a rear surface 21 side that is the opposite side of the reflection surface 14 of the mirror 11. Then, the pressure application portion 18Rb of the plate spring 18R is in contact with the rear surface 21 of the mirror 11 at a position corresponding to a substantial center between the seating surface 15a and seating surface 15b of the base 15. The mirror 11 is then urged by the plate spring 18R and is in contact with the seating surfaces 15a and 15b of the base 15. In addition, the surface 16 of the mirror 11 is brought into contact with the supporting projection portion 17a of the optical box 5 by an assembly worker pressing a surface 22 of the mirror 11.

As illustrated in FIG. 4, the plate spring 18L at the one end in the longitudinal direction of the mirror 11 is arranged on the rear surface 21 side that is on the opposite side of the reflection surface 14 of the mirror 11. A pressure application portion 18Lb of the plate spring 18L is in contact with the rear surface 21 of the mirror 11 at a position corresponding to the seating surface 55a of the base 55. The mirror 11 is urged by the plate spring 18L and is in contact with the seating surface 55a of the base 55. In addition, the surface 16 of the mirror 11 is brought into contact with the support projection portion 57a of the optical box 5 by the assembly worker pressing the surface 22 of the mirror 11.

While the plate springs 18R and 18L that urge the mirror 11 at the different two positions in the longitudinal direction of the mirror 11 have an identical configuration, positions at which the plate springs 18R and 18L are mounted onto the optical box 5 (a distance between the plate spring 18R and a plate spring mounting portion 5a and a distance between the plate spring 18L and a plate spring mounting portion 5b) are different from each other. As illustrated in FIG. 3, the plate spring 18R urges the mirror 11 toward the first positioning portion 13 having the two seating surfaces 15a and 15b of the optical box 5. In addition, the rear surface 18Ra of the plate spring 18R is in contact with the plate spring mounting portion 5a of the optical box 5. A distance between the plate spring mounting portion 5a and the pressure application portion 18Rb is a distance L1. In addition, as illustrated in FIG. 4, the plate spring 18L urges the mirror 11 toward the second positioning portion 53 having the seating surface 55a of the optical box 5. In addition, the rear surface 18La of the plate spring 18L is in contact with the plate spring mounting portion 5b of the optical box 5. A distance between the plate spring mounting portion 5b and the pressure application portion 18Lb is a distance L2. The distances L1 and L2 corresponding to bending amounts of the plate springs, respectively, have a relationship of L1<L2, and the bending amount of the first urging member 18R is smaller than the bending amount of the second urging member 18L. In this manner, despite the usage of the plate springs 18R and 18L having the identical configuration, a force of pressure F1 of the plate spring 18R is greater than a force of pressure F2 of the plate spring 18L (F1>F2).

As described above, the first positioning portion 13 has the two seating surfaces that hold the mirror 11, and the second positioning portion 53 has only one seating surface that holds the mirror 11, and the force of pressure F1 of the first urging member 18R is greater than the force of pressure F2 of the second urging member 18L.

### <Influence of Accuracy of Seating Surface>

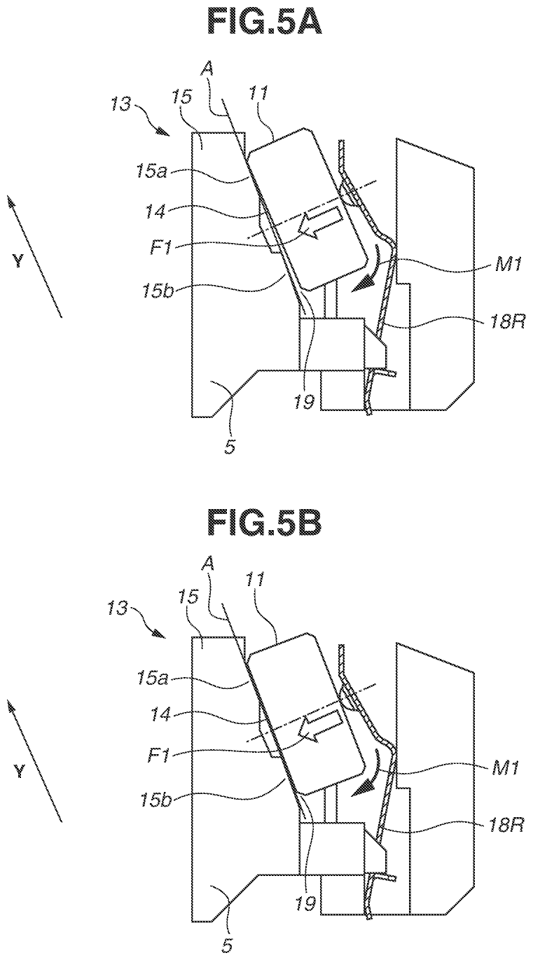

FIGS. 5A and 5B are diagrams illustrating a case where accuracy of the seating surface deteriorates due to a variation in molding the optical box 5, and illustrating a state where a gap is generated between the mirror 11 and the seating surface 15b. As illustrated in FIG. 5A, in a case where an angle of a straight line A connecting the seating surfaces 15a and 15b and an angle of the reflection surface 14 of the mirror 11 are different from each other, the reflection surface 14 of the mirror 11 is in contact with the seating surface 15a, and a gap 19 is generated between the remaining seating surface 15b and the mirror 11. As described above, the force of pressure F1 of the plate spring 18R is greater than the force of pressure F2 of the plate spring 18L, and the moment M1 generated by the force of pressure F1 brings the reflection surface 14 of the mirror 11 into contact with the seating surface 15b, thereby enabling elimination of the gap 19.

FIG. 5B is a diagram illustrating a state in which rotation of the mirror 11 by the moment M1 brings the mirror 11 into contact with the two seating surfaces 15a and 15b. Assuming that the force of pressure F1 of the plate spring 18R is about 10 N and a length in the traverse direction (Y-direction) of the mirror is 10 mm, the moment M1 is 50 Nmm. The moment of this magnitude can eliminate the gap 19 and cause the reflection surface 14 to be along the seating surfaces 15a and 15b even in a case where the angle of the straight line A connecting the seating surfaces 15a and 15b and the angle of the reflection surface 14 are different from each other.

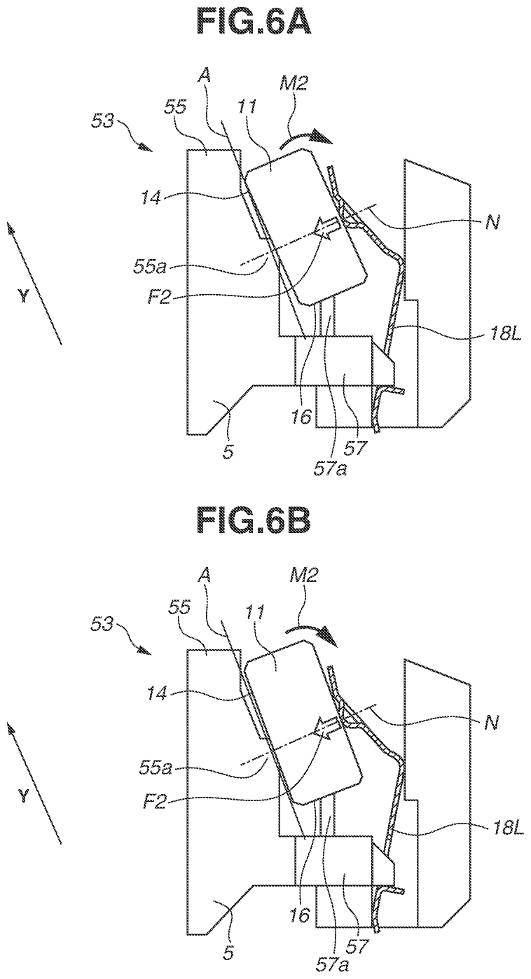

Next, the second positioning portion 53 will be described with reference to FIGS. 6A and 6B. As illustrated in FIG. 6A, in the second positioning portion 53, placing the mirror 11 on the optical box 5 generates the moment M2 corresponding to the moment M1 generated in the first positioning portion 13. The moment M2 rotates the mirror 11, thereby making the angle of the reflection surface 14 the same as the angle of the straight line A connecting the seating surfaces 15a and 15b.

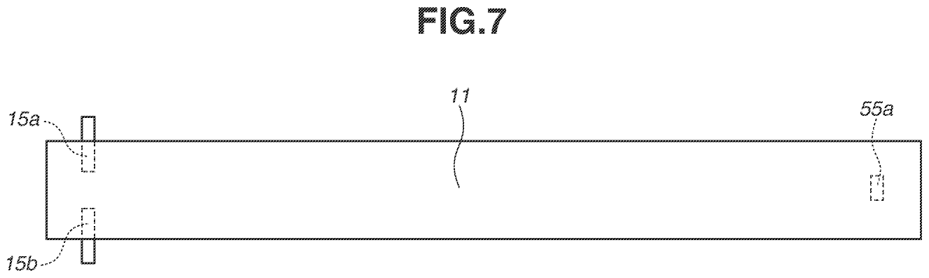

In the present exemplary embodiment, the pressure application portion 18Lb of the plate spring 18L is in contact with a substantial central portion of the mirror 11 in the Y-direction, and applies pressure to the mirror 11 by the force of pressure F2 on a line N connecting the seating surface 55a and the pressure application portion 18Lb. Furthermore, each of the seating surface 55a in contact with the reflection surface 14 of the mirror 11 and the support projection portion 57a in contact with the surface 16 of the mirror 11 are set to have a small area of about 2 to 4 mm². With such a configuration, the mirror 11 is easy to rotate by the moment M2, and the mirror 11 maintains a state of being in contact with the seating surface 55a and is never separated from the seating surface 55a. As illustrated in FIG. 7, the mirror 11 is in contact with the seating surfaces 15a and 15b at the different two positions at one end in the longitudinal direction (on the first positioning portion 13 side), and in contact with the seating surface 55a at the one position at the other end (on the second positioning portion 53 side), i.e., in contact with the optical box 5 at a total of three positions.

Such a configuration described above can reduce a variation in irradiation position of the laser beam due to the rotation of the mirror 11. The orientation of the mirror 11 is an important parameter that determines a position at which the photosensitive member, which is not illustrated, is irradiated with the laser beam. It is important to cause the mirror 11 to be along the seating surfaces 15a and 15b that determine the angle (orientation) of the mirror 11 at the two positions. Increasing the force of pressure F1 of the plate spring 18R on the first positioning portion 13 side having the two seating surfaces 15a and 15b to determine the angle of the mirror 11 causes the mirror 11 to be along the seating surfaces 15a and 15b at the two positions even in a case where accuracy in molding the seating surface has deteriorated. In contrast, there is no element that determines the angle of the mirror 11 on the second positioning portion 53 side having only one seating surface 55a. Thus, it is only required to make the force of pressure F2 of the plate spring 18L less than the force of pressure F1 of the plate spring 18R to prevent the force of pressure F2 from canceling out the moment M1.

As described above, the present exemplary embodiment can infallibly bring the mirror 11 into contact with the three seating surfaces 15a, 15b, and 55a, even in a case where the accuracy of the seating surface of the optical box 5 to mount the mirror 11 is not good, and can reduce displacement of irradiation position of the laser beam L due to vibration of the mirror 11. While the plate springs 18R and 18L apply pressure to the rear surface 21 of the mirror 11 in the present exemplary embodiment, the plate springs 18R and 18L may be configured to apply pressure to the reflection surface 14 of the mirror 11 and bring the rear surface 21 in contact with the seating surface. In addition, while the description has been given of the example in which the gap is generated between the mirror 11 and the seating surface 15b, the configuration of the present exemplary embodiment can exhibit similar effects even in a case where the gap is generated between the mirror 11 and the seating surface 15a.

Furthermore, the force of pressure of the plate spring 18R on the first positioning portion 13 side having the two seating surfaces is only required to be greater than the force of pressure of the plate spring 18L on the second positioning portion 53 side having only one seating surface. A configuration of using different plate springs for the two plate springs may be employed. More specifically, forces of pressure may be differentiated by differentiating thicknesses of the two plate springs. Alternatively, forces of pressure may be differentiated by differentiating lengths of action of the two plate springs (lengths from points of support to points of action of the plate springs). Still alternatively, forces of pressure may be differentiated by differentiating bending amounts of the two plate springs (displacement amounts of points of support of the plate springs).

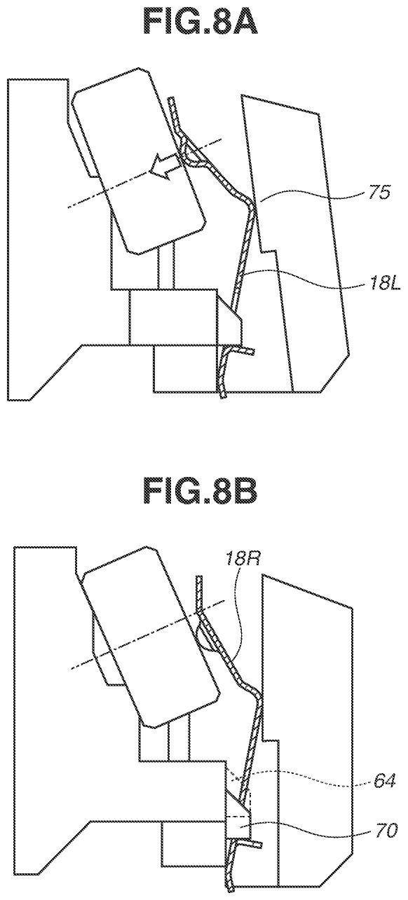

In addition, even in a case where the two plate springs have the identical configuration, forces of pressure may be differentiated by a configuration of inclining a plate spring mounting portion 75 toward the gravitational direction as illustrated in FIG. 8A, or a configuration of changing a height of the plate spring by shifting a height position of the claw 64 toward the gravitational direction as illustrated in FIG. 8B.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2020-063776, filed Mar. 31, 2020, which is hereby incorporated by reference herein in its entirety.

What is claimed is:

1. An optical scanning apparatus, comprising:
a light source configured to emit a laser beam;
a deflector configured to deflect the laser beam emitted from the light source and perform scanning with the laser beam;
a mirror having a length greater than its width and configured to reflect the laser beam;
an optical box, configured to house the deflector and the mirror, including a first positioning portion configured to hold one end of the mirror and a second positioning portion configured to hold the other end, in the longitudinal direction, of the mirror;
a first urging member configured to urge the mirror toward the first positioning portion; and
a second urging member configured to urge the mirror toward the second positioning portion,
wherein the first positioning portion has two seating surfaces configured to hold the mirror, and the second positioning portion has one seating surface configured to hold the mirror, and
wherein a force of pressure of the first urging member is greater than a force of pressure of the second urging member.

2. The optical scanning apparatus according to claim 1,
wherein the first urging member and the second urging member have an identical configuration, and a bending amount of the first urging member is smaller than a bending amount of the second urging member.

3. The optical scanning apparatus according to claim 1,
wherein the first urging member includes a first pressure application portion that contacts the mirror and configured to apply the force of pressure of the first urging member to the mirror, and
wherein the first pressure application portion is, when the mirror is viewed in the longitudinal direction, in contact with the mirror at a position corresponding to an intermediate position between the two seating surfaces of the first positioning portion in a sub-scanning direction.

4. The optical scanning apparatus according to claim 3,
wherein the second urging member includes a second pressure application portion that contacts the mirror and configured to apply the force of pressure of the second urging member to the mirror, and
wherein the second pressure application portion is, when the mirror is viewed in the longitudinal direction, in contact with the mirror at a position corresponding to a position of the seating surface of the second positioning portion in the sub-scanning direction.

5. The optical scanning apparatus according to claim 4,
wherein an area of a portion, which is in contact with the mirror, of the seating surface of the second positioning portion is 2 to 4 mm².

6. The optical scanning apparatus according to claim 5,
wherein the optical box includes a projection portion contacting a surface of the mirror orthogonal to a surface of the mirror that is in contact with the second pressure application portion, and an area of a portion, which is in contact with the mirror, of the projection portion is 2 to 4 mm².

7. The optical scanning apparatus according to claim 1,
wherein each of the first urging member and the second urging member is a plate spring, and
wherein each of the first urging member and the second urging member is configured to generate the force of pressure to urge the mirror by being disposed between the optical box and the mirror.

8. The optical scanning apparatus according to claim 7,
wherein the first urging member includes a first hole configured to engage with a first claw arranged on the optical box to fix the first urging member to the optical box, and the second urging member includes a second hole configured to engage with a second claw arranged on the optical box to fix the second urging member to the optical box.
